(19) United States
(12) Patent Application Publication
(10) Pub. No.: US 2024/0117922 A1
(43) Pub. Date: Apr. 11, 2024

(54) VEHICLE STAND

(71) Applicant: PICK-N-PULL AUTO DISMANTLERS, Portland, OR (US)

(72) Inventors: Michael Brinkley, El Dorado Hills, CA (US); Peter Joseph Weiss, Lodi, CA (US)

(21) Appl. No.: 18/552,413

(22) PCT Filed: Apr. 28, 2022
(86) PCT No.: PCT/US22/71981

§ 371 Date: Sep. 25, 2023

Related U.S. Application Data
(60) Provisional application No. 63/182,677, filed on Apr. 30, 2021.

(51) Int. Cl. F16M 11/22

(52) U.S. Cl. CPC F16M 11/22

(57) ABSTRACT

The disclosed vehicle stands have a base, a top plate, and a mechanical stop on the top plate that hold a vehicle in a secure, suspended position above a surface, such as the ground or a floor. The top plate can be removable from the base. The base has two legs that extend away from the top plate. The top plate can be flat or contoured to compliment a shape of a vehicle resting upon it. The top plate can include additional securing elements, such as a friction that on a surface that contacts a suspended vehicle and a locking mechanism that attaches to the suspended vehicle. Multiple vehicle stands can be used together. Two of the multiple stands can be connected by a cross-bar that extends under the vehicle as it is suspended above the surface by the two respective top plates.

### CROSS-REFERENCE TO RELATED APPLICATIONS

This application is a 371 filing of International Patent Application No. PCT/US22/71981, filed Apr. 28, 2022, entitled “VEHICLE STAND,” which claims priority and benefit from U.S. Provisional Patent Application 63/182,677, filed Apr. 30, 2021, and titled, “VEHICLE STAND” which is incorporated herein by reference in its entirety for all purposes.

### BACKGROUND

Vehicles often need to be elevated from a surface for repair, maintenance, and inspection. Even personal vehicles weigh thousands of pounds and, when elevated, pose a safety risk to a human within a zone of danger of the elevated vehicle. Some applications like vehicle repair center or vehicle dealerships install large, permanent systems that securely lock and elevate vehicles to properly secure and position them for the desired repair, maintenance, and inspection. Such systems are typically only installed in large commercial settings and are operated only by skilled and trained technicians. These systems are also permanently installed in a location, expensive, heavy, and require their own periodic maintenance, repair, and inspections. Because of the expense, permanent installation, and operational requirements, these commercial systems are impractical for non-commercial use or use that may require a vehicle to be moved.

In many applications, vehicles need to be elevated for repair, maintenance, inspection, or other reasons but a smaller, less expensive system is required that does not demand a highly skilled operator for safe use. For example, many vehicle owners wish to perform repairs, maintenance, and inspections on their vehicles for personal use or in small commercial settings. Others wish to perform such tasks on vehicles that have been damaged beyond repair to disassemble certain portions of vehicles for parts recycling. The elevation techniques typically used in these settings include a pair of posts each with a tire placed on top of it. The posts are placed on opposing ends of the vehicles. The vehicle is not secured to the stand nor is either stand secured to the surface upon which it sits. Elevated vehicles slide from the post or the posts slide on the surface, both of which can cause the vehicle to slip off the stand and fall to the surface. When a vehicle falls to the surface, people can be seriously injured or die, especially if they are located within a close proximity of the falling vehicle.

There is a need in the industry to improve the safety of elevating vehicles using a low-cost, portable system.

### BRIEF DESCRIPTION OF THE DRAWINGS

Non-limiting and non-exhaustive embodiments of the invention are described with reference to the following drawings. In the drawings, like reference numerals refer to like parts throughout the various figures, unless otherwise specified, wherein:

FIG. 1 is a perspective view of an example vehicle stand.

FIG. 2 is a perspective view of two example vehicle stands with an attached center beam.

FIG. 3 is a top plan view of the two example vehicle stands shown in FIG. 2.

FIG. 4 is a side plan view of the two example vehicle stands shown in FIG. 2.

FIG. 5A shows an example vehicle stand and a conventional stand supporting a front and rear area of a vehicle to suspend it above a surface.

FIG. 5B shows two example vehicle stands supporting a vehicle at both the front and rear area to suspend it above a surface.

FIG. 6A is an example top plate of a disclosed vehicle stand.

FIG. 6B is another example top plate of a disclosed vehicle stand.

FIG. 6C is yet another example top plate of a disclosed vehicle stand.

FIG. 7A is an example base of a disclosed vehicle stand.

FIG. 7B is another example base of a disclosed vehicle stand.

FIG. 7C is still another example base of a disclosed vehicle stand.

FIG. 8A is an example cross-bar of a disclosed vehicle stand.

FIG. 8B is another example cross-bar of a disclosed vehicle stand.

FIG. 9A is an example foot of a disclosed vehicle stand.

FIG. 9B is another example foot of a disclosed vehicle stand.

FIG. 9C is yet another example foot of a disclosed vehicle stand.

### DETAILED DESCRIPTION

The disclosed vehicle stands secure vehicles in an elevated position to improve the safety and easy of providing maintenance, repair, and inspection of the elevated vehicle. Further, they provide portable options that reduce the storage and transport space required for the stands. The vehicle stands secure elevated vehicles anywhere along the vehicle to elevate it for various purposes, such as maintenance, repair, and inspection or for removal of parts, for example. People perform these tasks on the elevated vehicles. Their physical safety and ease of performing the tasks is improved with the disclosed vehicle stands. The vehicle stands suspend vehicles above a surface, such as the ground. The platform can be made any size, such as a 20″ or more contact surface with the vehicle. The platform can be flat or contoured to mate with the shape of a portion of the vehicle it is intended to suspend above the surface.

Because of the weight they bear and the safety risk to humans that are in physical proximity to elevated vehicles using the disclosed vehicle stands, the stands are often made of a strong, rigid material(s), such as steel or another formidable metal. However, they can be made of metal alloys, composites, or the like that can provide the necessary weight-bearing qualities and safety requirements for the vehicles being elevated by the stands.

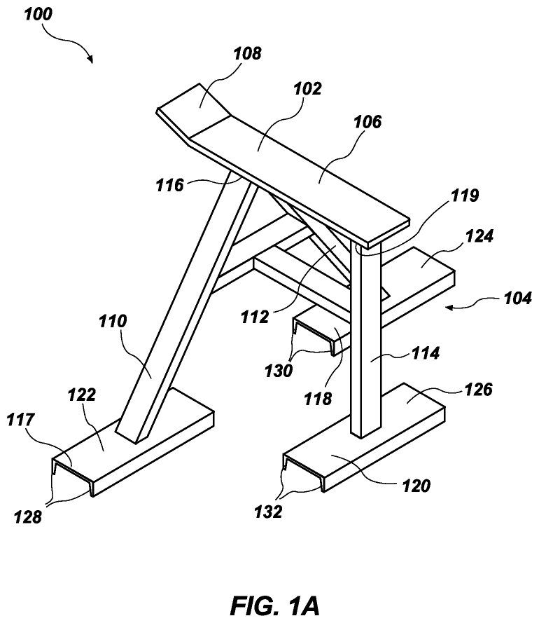

An example of a disclosed vehicle stand 100 has a platform 102 and a base 104, as shown in FIG. 1. The platform 102 supports the weight of a vehicle, such as an automobile, boat, farming or manufacturing equipment or the like. The platform 102 is positioned between an underside of the vehicle and the surface on which it sits, which is discussed in more detail below. The platform 102 is any suitable shape or size. In the example shown in FIG. 1, the platform 102 is flat and elongated. The platform 102 includes a main body portion 106 and a securing element 108. The main body portion 106 is placed beneath the main body of the vehicle at a desired location along its length. The securing element 108 is angled at an end of the main body portion 106 of the platform 102 and, when the main body portion 106 is supporting the elevated vehicle, prevents the body of the vehicle from substantial lateral movement by contacting a side surface of the vehicle as a mechanical stop. The platform 102 can include a releasable locking mechanism (not shown) that locks to a portion of the vehicle after the vehicle is in place, then releases to allow the vehicle to be removed from the stand. The locking mechanism can be mechanically controlled with a lock and key or automatically controlled via electronics that control it to restrict access to control of the lock. The locking mechanism allows for only authorized controllers to lock and unlock vehicles on the stands. The angle of the securing element 108 shown in FIG. 1 is 15° from the plane of the main body portion 106. In alternative example, the angle is any suitable angle up to and exceeding 90°.

FIG. 1 shows a base 104 attached to and supporting the platform 102. In this example, the based has three legs 110, 112, and 114. The base 104 can alternatively have any number of legs. In this example, two of the legs 110, 112 are attached to and extend away from the platform 102 at a first location 116 and the third leg 114 is attached to and extends away from the platform 102 at a second location 119 spaced apart from the first location. The distance between the first location 116 and the second location 119 can increase or decrease in other examples. The distance between the first location 116 and the second location 119 provides stability to the elongated platform 102 shown in FIG. 1. The configuration of the base 104—both the number of legs and the location(s) at which they attach to the platform 102—can vary depending on the shape and form of the platform 102.

In the example shown in FIG. 1, the two legs 110, 112 attached to the first location 116 of the platform 102 extend away from the platform 102 at an angle to form an “A” configuration with respect to the platform 102. In some examples, the apex of the angle of the “A” configuration is approximately 30°-60°. The two legs 110, 112 could be attached to the platform 102 at the first location 116 with a hinge that allows the first leg 110 and the second leg 112 to collapse during storage or shipping, for example. In the hinged d examples, a stabilizing bar can also be included that extends between the two legs 110, 112, such as a slip unit, joint, or coupler, to secure the two supports in a stable position during use. In other examples, the first leg 110 and the second leg 112 are fixed to the platform 102, such as by a weld. FIG. 1 shows an example with legs 110, 112, and 114 that have quadrilateral cross-section although alternatives could have a curved, circular, ovular, or other shape, with or without a hinge at the point they attach to the platform 102.

The third leg 114 attached to the second location 119 of the platform 102 at a right angle with respect to the platform 102. The A-configuration provides a wider base below the first location 116 than the third leg 114 attached to the platform 102 at the right angle. This configuration provides three points of contact between the base 104 and the surface on which it sits.

Each of the legs 110, 112, and 114 of the base 104 shown in FIG. 1 includes a footing 117, 118, and 120, respectively. In this example, the footings 116, 118, and 120 are each shaped and structured the same; however, footings could be shaped and structured differently. For example, one footing could have a mechanism that pierces the surface on which the vehicle stands sits while another footing(s) could have a grip that contacts the surface on which the vehicle stands sit. The footings 116, 118, and 120 shown in FIG. 1 each have an elongated flat portion 122, 124, and 126 each with a pair of lateral side walls 128, 130, and 132 that extend at right angles from the elongated flat portions 122, 124, and 126 to contact the surface on which the vehicle stand 100 sits. The lateral side walls 128, 130, and 132 taper to a point or rounded edge in this example to pierce the surface on which the vehicle stands sit, which is often an outdoor surface like some combination of dirt and gravel. That piercing capability of the lateral side walls 128, 130, and 132 prevents lateral movement of the vehicle stand because it extends into the surface by some distance, especially when the weight of the vehicle is atop the vehicle stand.

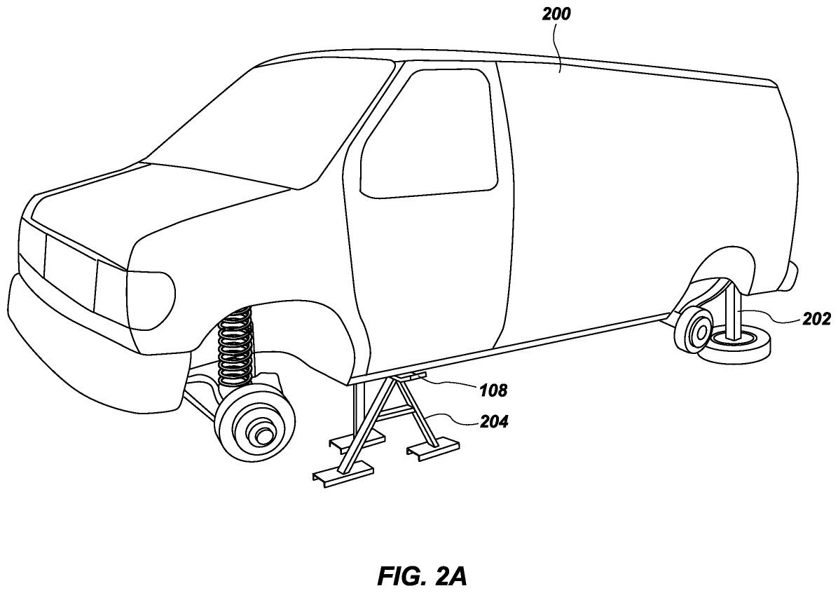

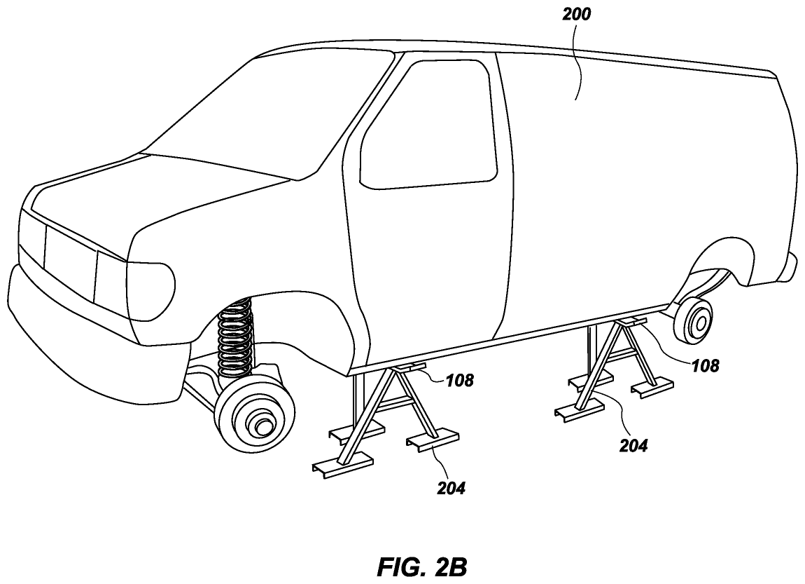

FIG. 2A shows a vehicle elevated on three vehicle stands 202, 204 (third stand is not shown in this view). The first vehicle stand 202 is positioned underneath the rear of the vehicle 200 in a center portion to approximately balance the weight of the backend of the vehicle 200. At the opposing front end of the vehicle 200, two disclosed vehicle stands are placed on either side of the vehicle 200. The embodiments of the vehicle stand shown in FIG. 2A is shown in FIG. 1. The two front end vehicle stands 204 and the opposing stand that is not shown, provide support to elevate the vehicle 200 at the front end. The securing elements of each of the front end vehicle stands, 204 and the one not shown, help reduce lateral movement of the vehicle when it is elevated on the stands. Without these securing elements 108, the vehicle would be free to move laterally and could slip off the stands. Further, because there are two stands as opposed to a single stand configuration, the support to elevate the vehicle is distributed across the front end of the vehicle 200 rather than concentrated at a single point. The conventional rear end vehicle stand 202 concentrates the support to elevate the vehicle at a single, central location. Typically, the conventional rear end vehicle stands have been used on both ends of the vehicle so the lateral movement restriction offered by the two front end distributed A-frame configuration vehicle stands, 204 and the opposing stand that is not shown, improves the likelihood that the vehicle will remain in place when it is elevated on the vehicle stands.

FIG. 2B shows an elevated vehicle 200 with two sets of the A-frame configuration vehicle stands 204—one pair on opposing sides of the front end of the vehicle, similar to the embodiment shown in FIG. 2A, and the second pair on opposing sides of the rear end of the vehicle, replacing the conventional centrally positioned vehicle stand shown in FIG. 2A. This configuration of FIG. 2B distributes the support to elevate the vehicle at both the front end and the back end of the vehicle and provides restricted lateral movement through the securing elements 108 on each pair of vehicle stands to further improve the likelihood that the vehicle will remain elevated on the vehicle stands.

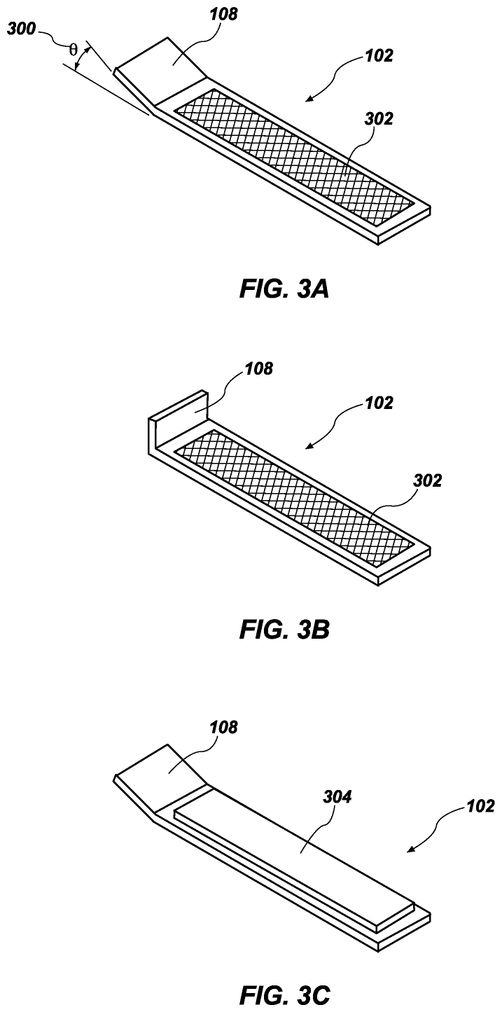

FIGS. 3A-3C show various mechanical elements that can be placed on the flat surface of the platform 300 of the vehicle stands that contact the vehicle. These mechanical elements provide increased friction force or hard mechanical stops to reduce or eliminate movement of the vehicle when elevated on the vehicle stand. FIG. 3A shows a platform 102 having an angle θ 300 that is approximately 15° from the plane of the platform 102. The angled securing element 108 provides a mechanical stop or reduction in lateral movement when a vehicle is elevated on the stand. The platform 102 shown in FIG. 3A also includes an anti-skid pad 302 that has a lattice of ridges that contact the elevated vehicle. Alternatively, the platform 102 can include a grate that serves as an anti-skid pad.

FIG. 3B shows another platform 102 similar to the platform 108 shown in FIG. 3A except its securing element 108 is at a right angle with respect to the platform 102. The embodiment shown in FIG. 3B has the same anti-skid pad 302 as the embodiment shown in FIG. 3A that helps maintain the vehicle in an elevated position. FIG. 3C is yet another example platform 102 that has an angled securing element 108 that is approximately 15° from the plane of the platform 102 to provide the same lateral movement prevention as the embodiment shown in FIG. 3A. This platform 102 also includes an attenuation pad 304 that is placed along the flat surface of the platform 108. The attenuation pad 304 absorbs some of the force of the weight of the elevated vehicle and provides an intermediate layer between the vehicle and the platform 108 to reduce lateral movement of the vehicle when it is elevated. Any suitable mechanical mechanism or layer can be added to increase friction or prevent lateral movement of the elevated vehicle with respect to the platform 102.

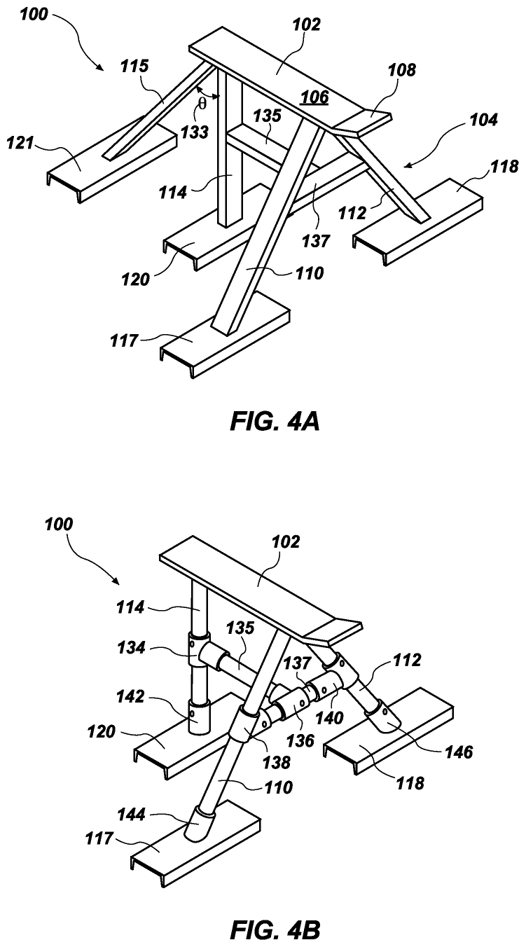

Turning now to FIGS. 4A and 4B, shown alternative base configurations for the disclosed vehicle stands. FIG. 4A shows a vehicle stand with the same configuration of FIG. 1A except it has a fourth leg 115 with a corresponding footing 121. In this example, the fourth leg 115 and the corresponding footing 121 are the same embodiment as the first leg 110, the second 112, and the third leg 114 and their corresponding footings 117, 118, and 120. In alternative examples, the legs or the footings could be different embodiments. In this example, the fourth leg 115 extends away from the platform 102 at an angle θ 123 from the third leg 114. The footprint of the vehicle stand 100 shown in FIG. 4A is greater in length and width than the platform 102 extends to support the vehicle when elevated, which gives the vehicle a stable, wider base than a post like the conventional vehicle stand 202 shown in FIG. 2A.

FIG. 4B is a similar configuration to the vehicle stand shown in FIG. 1A except it includes components that can be fitted together at various joints 134, 136, 138, 140, 142, 144, and 146. Joints 134, 136 are T-joints that connect a cross-bar 135 to an A-bar 137 that extends between the first leg 110 and the second leg 112. The cross-bar 135 secures the third leg 114 to the first leg 110 and the second leg 112. The first leg 110, second leg 112, third leg 114, and fourth leg 115 can be detached from the cross-bar 135 and the A-bar 137 when these joints are detached 134, 136. Further, the first leg 110 is attached to the joint 138 and can be detached from the A-bar 137 at the same joint 138 when needed. Similarly, the second leg 112 is attached to the joint 140 and can be detached from the A-bar at the same joint 140. The first leg 110 and the second leg 112 also have respective joints 144, 146 to attached to their respective footings 117, 118. The first leg 110 and the second leg 112 can be detached from their respective footing joints 144, 146 to remove or detach the footings 117, 118, from the legs 110, 112. Likewise, the third leg 114 is attached to and detachable from its footing 120 via a joint 142. This modular nature of the legs 110, 112, and 114 being attached to but detachable from their respective footings 117, 118, and 120 allows the vehicle stand 100 to be disassembled, such as for easy storage or transport, for example.

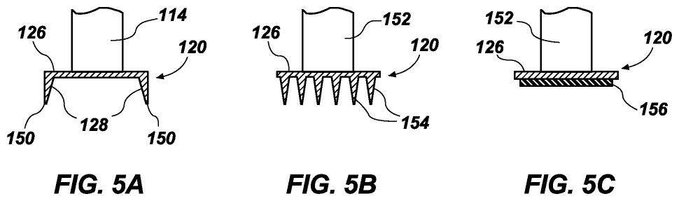

Turning now to FIGS. 5A-5C, the footings of each leg of the vehicle stand has a configuration that may include a gripping element to improve the ability of the footing to be stationary with respect to the surface on which the vehicle stand sits. For example, FIG. 5A includes the embodiment of the exemplary footing 120 of the third leg 114 of the vehicle stand 100 shown in FIG. 1A. This footing 120 has an elongated platform 126 with two opposing, lateral side walls 128 that extend away from the elongated platform 126. The lateral side walls 128 are tapered as they extend towards the surface on which the vehicle stand 100 sits. The tapered ends 150 of each lateral side wall 128 comes to a narrower point that contacts the surface to provide some grip between the vehicle stand 100 and the surface. For example, the vehicle stand 100 is often placed on a soft surface, such as dirt, gravel, or grass. The tapered ends 150 of each lateral side wall 128 pierces or causes the surface to flex to provide more grip and increased friction required to cause lateral movement of the footing 120 and thus the entire vehicle stand 100.

FIGS. 5B and 5C show alternative example footing embodiments. The configuration shown in FIG. 5B includes multiple tapered spikes 154 that extend away from the elongated platform 126 towards the ground. Like the tapered ends of the embodiment shown in FIG. 5A, these tapered spikes 154 pierces the surface or cause it to flex to provide improved gripping and increased friction required to cause lateral movement of the footing 120 and thus the entire vehicle stand 100. FIG. 5C includes another footing embodiment in which a grip layer 156 is attached along the length of the elongated platform 126. The grip layer 156 can be any suitable material that causes increased friction between the elongated platform 126 of the footing 120 and the surface on which it sits. This type of grip layer embodiment of the footing helps provide increased friction in many environment, especially smooth surfaces such as concrete, asphalt, and a garage floor of any kind.

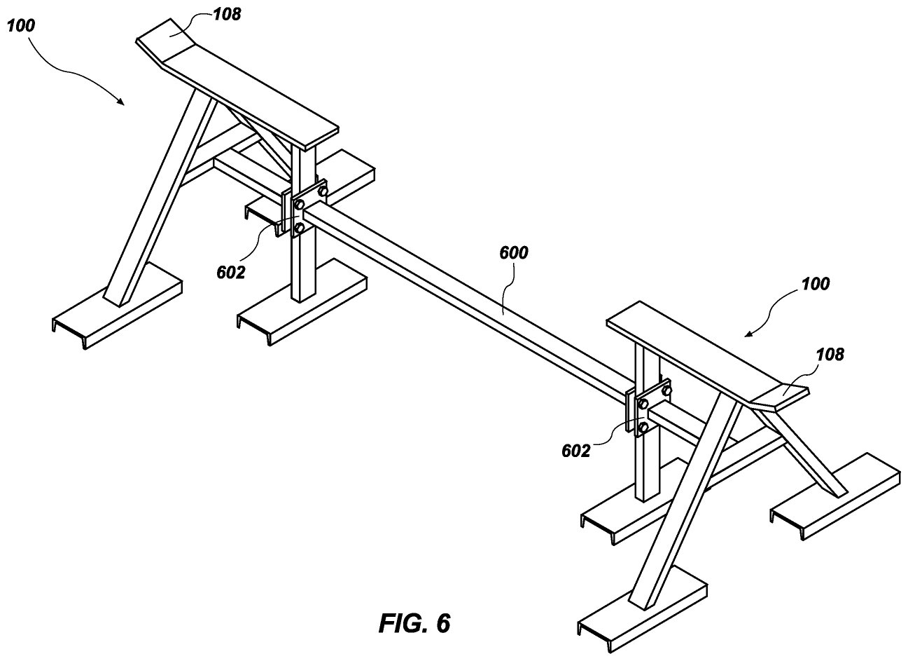

FIGS. 6-8 show an embodiment with two opposing vehicle stands 100, 100 connected by a support beam 600. For clarity, the example vehicle stands 100, 100 shown in FIGS. 6-8 are the same embodiment as the vehicle stand shown in FIG. 1. Any other embodiment of vehicle stand could be substituted for one or both of the vehicle stands 100, 100 shown in FIG. 6. The two vehicle stands can be the same or different embodiments. The securing elements 108 of each vehicle stand 100 angle towards the support beam 600, which is also towards a center portion of the vehicle when a vehicle is elevated on the vehicle stands. The support beam 600 secures the two vehicle stands 100, 100 to each other to align the vehicle stands 100, 100 with respect to each other beneath the vehicle. The securing elements 108 provide a mechanical stop or mitigation of lateral movement of the vehicle in either direction.

The support beam 600 is secured to both of the vehicle stands 100, 100 by a plate and set of bolts 602. The plate and bolts 602 is removeable from both the support beam 600 and each respective vehicle stand 100 in this example. In other examples, the plate and bolts 602 can be removeable from either the support beam 600 or one or both of the vehicle stands 100, 100. The plate and bolt 602 is shown in FIG. 6 although other detachable securing elements can be substituted on one or other sides of the support beam 600, as desired. The support beam 600 extends below the vehicle when it is elevated but does not physically contact the vehicle. Its purpose is to align and stabilize the two vehicle stands with respect to each other.

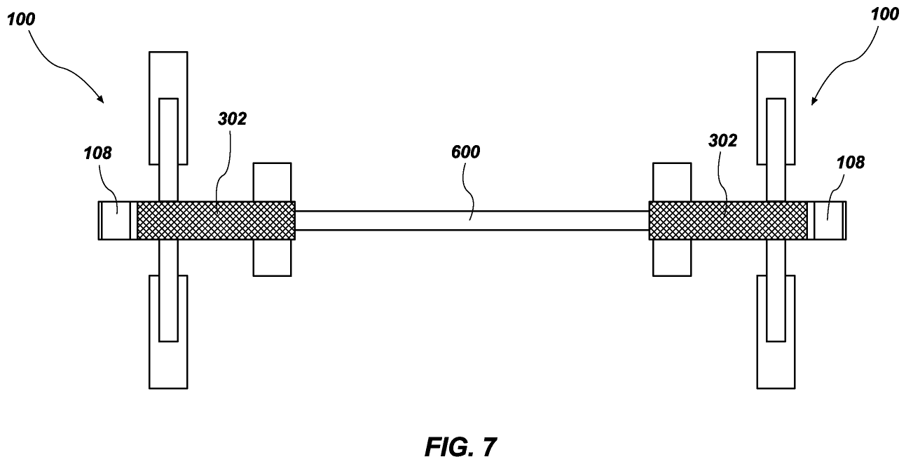

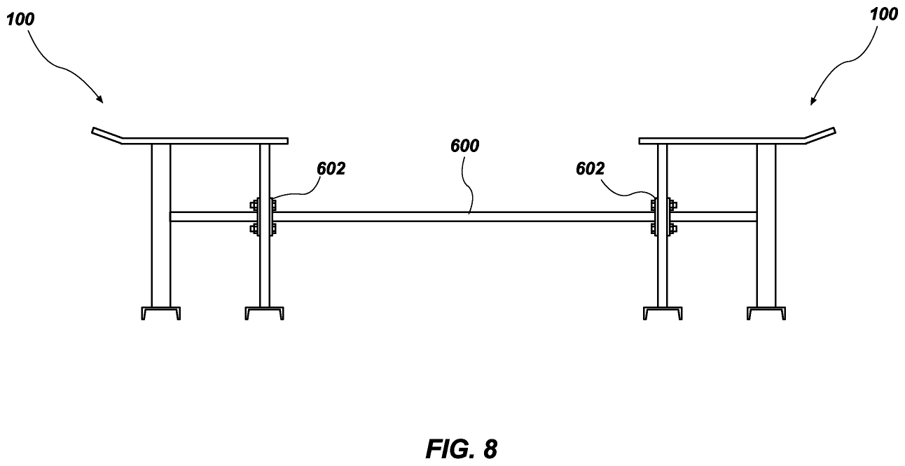

FIG. 7 shows a top plan view of the disclosed embodiment with two opposing vehicle stands 100, 100 connected by the support beam 600 that is shown in FIG. 6. This top plan view also shows an anti-skid pad 302 atop the main body portion 106 of the platform 102, as shown in the example platform 102 shown in FIGS. 3A and 3B. FIG. 8 shows a side view of the disclosed embodiment with two opposing vehicle stands 100, 100 connected by the support beam 600 that is shown in FIG. 6.

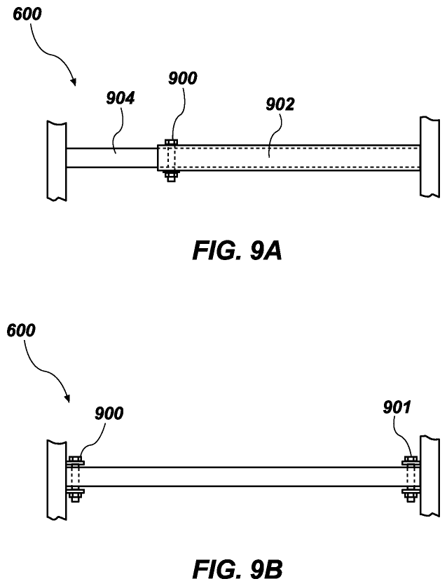

FIGS. 9A and 9B show another embodiment of the support beam 600 whose length can vary depending on where the adjustment element 900 is positioned along the length of the support beam 600. In this example, the support beam 600 includes two telescoping pieces 902, 904 with one 904 fitting into the other 902 to adjust its length, as desired. The support beam 600 in FIG. 9A is positioned in an extended position in which a portion of one of the telescoping pieces 904 is exposed while another portion is fitted within the cavity of the second piece 902. FIG. 9B shows an example support beam 600 with two adjustment elements 900, 901. These adjustment elements 900, 901 are positioned in their retracted position, which is as short of a distance between the vehicle stands as possible. When permitted, these adjustment elements 900, 901 cause the support beam 600 to telescope (not shown) to extend its length. Vehicles of different makes and models have different widths. Varying the length of the support beam 600 allows a user to correlate the length to the width of the vehicle being elevated. Correlating the support beam 600 length with the width of the vehicle provides a desired tolerance of space between the vehicle side surface and the securing elements 108 of the vehicle stands to keep the lateral movement to a minimum. This managed lateral movement decreases the likelihood that the vehicle will slip from the vehicle stand and improves the safety of the system. Any adjustable support beam can include a locking mechanism to secure the beam in the desired position.

These and other features of the disclosed novel vehicle stands provide improved stability of the vehicles and access to vehicle parts when placed on the stands. The stability improves the safety for people using these vehicle stands to avoid catastrophic or other injuries. Their modular nature allows for easy storage, shipping, and repair of the stands.

Though certain elements, aspects, components or the like are described in relation to one embodiment or example, such as an example vehicle stand, those elements, aspects, components or the like can be included with any other vehicle stand, such as when it desirous or advantageous to do so.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated.

Though certain elements, aspects, components or the like are described in relation to one embodiment or example, such as an example system, those elements, aspects, components or the like can be including with any other systems, such as when it desirous or advantageous to do so.

What is claimed is:

1. A vehicle stand system, comprising:
a base with two legs;
a top plate secured to the base;
a mechanical stop attached to an end of the top plate.

2. The system of claim 1, wherein the base includes two legs in an A-frame configuration.

3. The system of claim 1, wherein the base includes three legs.

4. The system of claim 3, wherein the top plate is a rectangular plate, and wherein two of the three legs are positioned on opposites sides of a first portion of the rectangular plate at or near a first end and a third of the three legs is positioned on a second portion of the rectangular plate at or near a second, opposing end of the first end.

5. The system of claim 3, wherein the top plate is secured to the base with at least two of the three legs spaced apart from each other at respective securing points to the top plate.

6. The system of claim 1, wherein at least a portion of the top plate is flat.

7. The system of claim 1, wherein the mechanical stop is a flat or contoured plate that extends away from the top plate at an angle.

8. The system of claim 7, wherein the angle is an obtuse angle.

9. The system of claim 7, wherein the angle is a right angle.

10. The system of claim 1, further comprising a friction layer or element attached to a surface of the top plate opposite a surface of the top plate that is secured to the base.

11. The system of claim 10, wherein the friction layer or element is a grate.

12. The system of claim 10, wherein the friction layer or element is an anti-skid layer.

13. The system of claim 1, further comprising feet attached to an end of each leg opposite the top plate.

14. The system of claim 13, wherein each of the feet includes a mechanical gripping element.

15. The system of claim 14, wherein the mechanical gripping element including a spike or anti-skid layer.

16. The system of claim 1, wherein the base includes a cross-bar attachment point.

17. The system of claim 16, wherein the cross-bar attachment point is a releasable mechanical connector.

18. The system of claim 16, wherein the cross-bar attachment point is integrated with a cross-bar.

19. The system of claim 1, further comprising a locking element attached to the top plate.

20. The system of claim 1, wherein the top plate is removable from the base.
